(19) United States
(12) Patent Application Publication
(10) Pub. No.: US 2026/0070098 A1
(43) Pub. Date: Mar. 12, 2026

(54) TOILET PLUNGER CLEANING APPARATUS

(71) Applicant: Tyler Bonadiman, Redlands, CA (US)

(72) Inventor: Tyler Bonadiman, Redlands, CA (US)

(21) Appl. No.: 18/883,381

(22) Filed: Sep. 12, 2024

(51) Int. Cl. B08B 9/00; E03D 9/00

(52) U.S. Cl. CPC B08B 9/00; E03D 9/00

(57) ABSTRACT

A toilet plunger cleaning apparatus for washing a cup of a toilet plunger in an enclosed chamber includes a housing which defines a plunger-receiving which extends through a top side of the housing into an interior space of the housing. The plunger-receiving opening is sized to receive the cup of the toilet plunger. A sprayer is mounted in the housing and is configured to selectively spray a fluid into the interior space of the housing. The sprayer comprises a head which is configured to dispense the fluid while rotating with respect to the housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to toilet plunger cleaning apparatuses and more particularly pertains to a new toilet plunger cleaning apparatus for washing a cup of a toilet plunger in an enclosed chamber.

### (2) Description of Related Art Including Information Disclosed Under 37 CFR 1.97 and 1.98

The prior art discloses various apparatuses for cleaning a toilet plunger in an enclosed housing. However, the prior art fails to describe such an apparatus with a sprayer mechanism that is configured to rotate to spray a cleaning fluid evenly onto a cup of the toilet plunger.

### BRIEF SUMMARY OF THE INVENTION

An embodiment of the disclosure meets the needs presented above by generally comprising a housing which defines a plunger-receiving which extends through a top side of the housing into an interior space of the housing. The plunger-receiving opening is sized to receive a cup of a toilet plunger. A sprayer is mounted in the housing and is configured to selectively spray a fluid into the interior space of the housing. The sprayer comprises a head which is configured to dispense the fluid while rotating with respect to the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a toilet plunger cleaning apparatus according to an embodiment of the disclosure.

FIG. 2 is a detail perspective view of an embodiment of the disclosure.

FIG. 3 is a top view of an embodiment of the disclosure.

FIG. 4 is a cross-section view of an embodiment of the disclosure taken from Line 4-4 in FIG. 3.

FIG. 5 is a detail view of an embodiment of the disclosure taken from Window in FIG. 4.

FIG. 6 is an exploded in-use view of an embodiment of the disclosure.

FIG. 7 is a front view of an embodiment of the disclosure.

FIG. 8 is a side in-use view of an embodiment of the disclosure.

FIG. 9 is a detail perspective view of a valve actuator of an embodiment of the disclosure.

FIG. 10 is an in-use view of an embodiment of the disclosure.

### DETAILED DESCRIPTION OF THE INVENTION

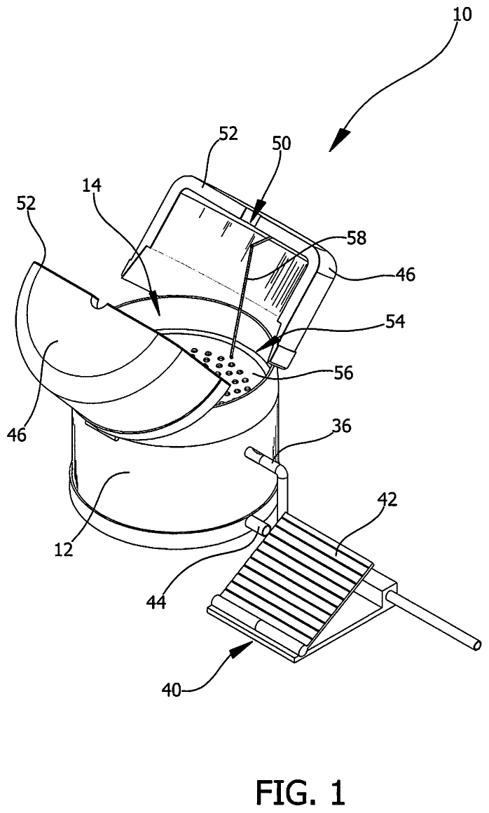

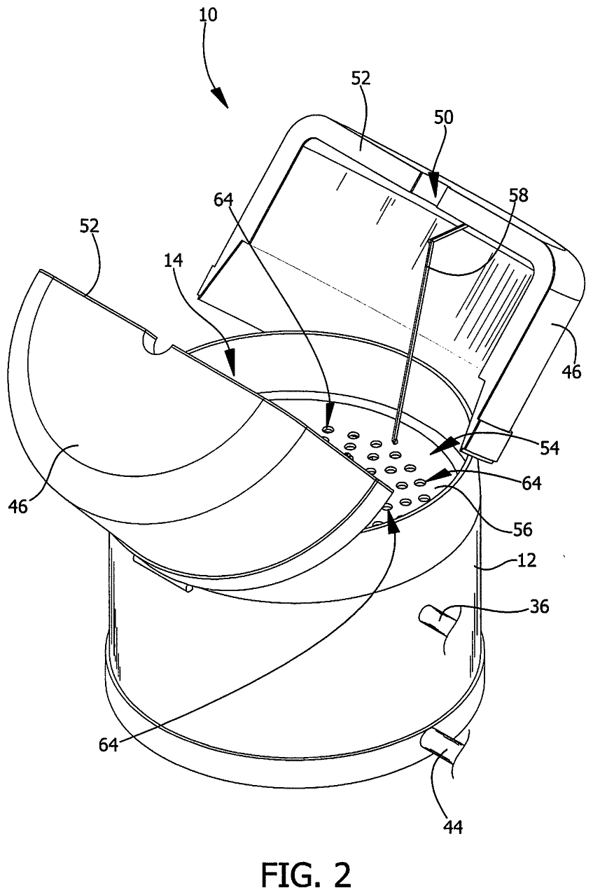

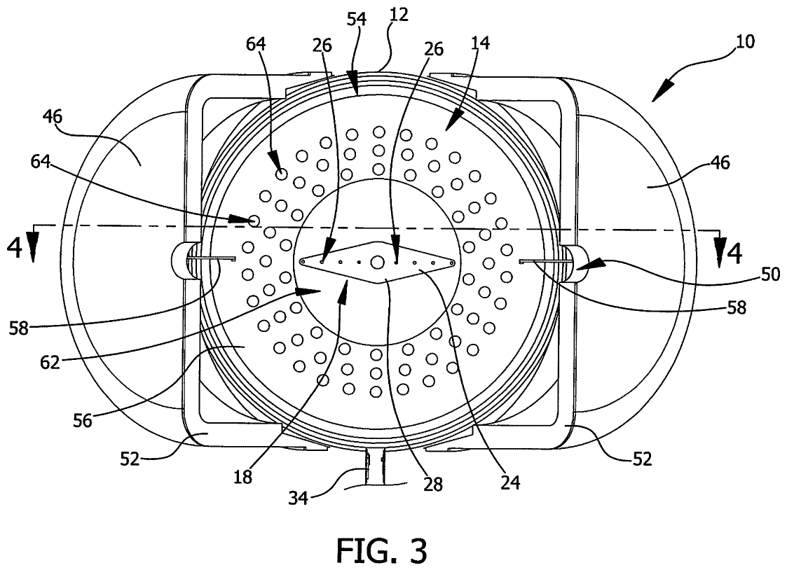

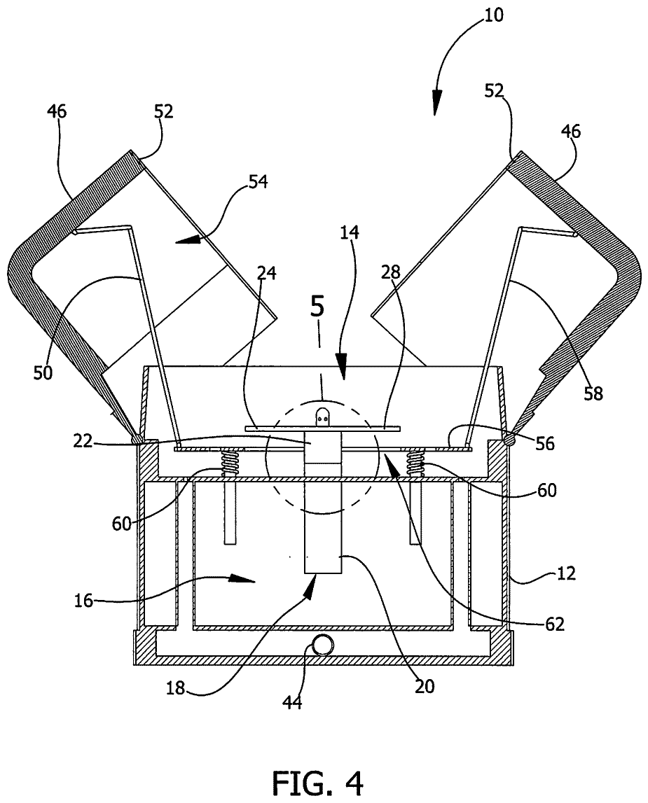

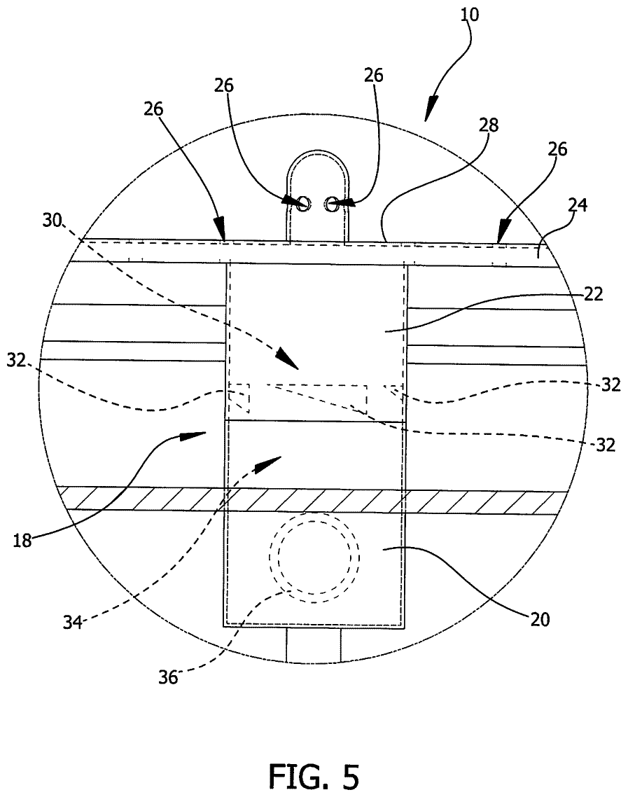

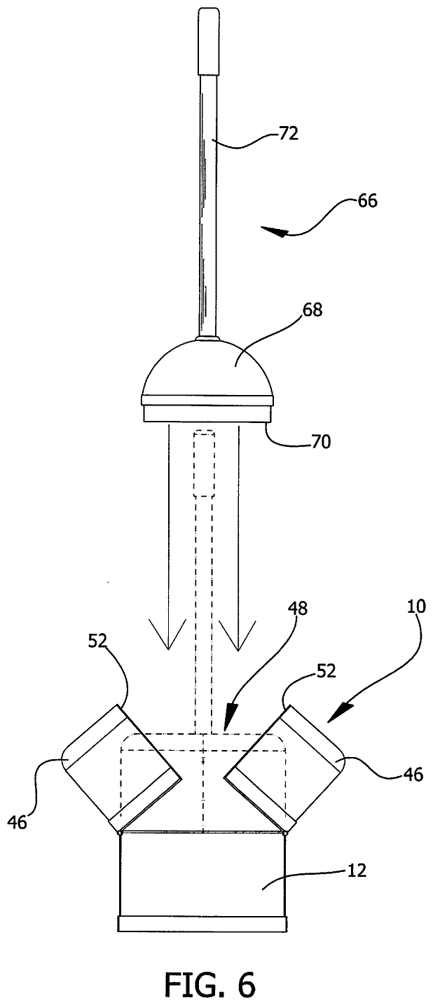

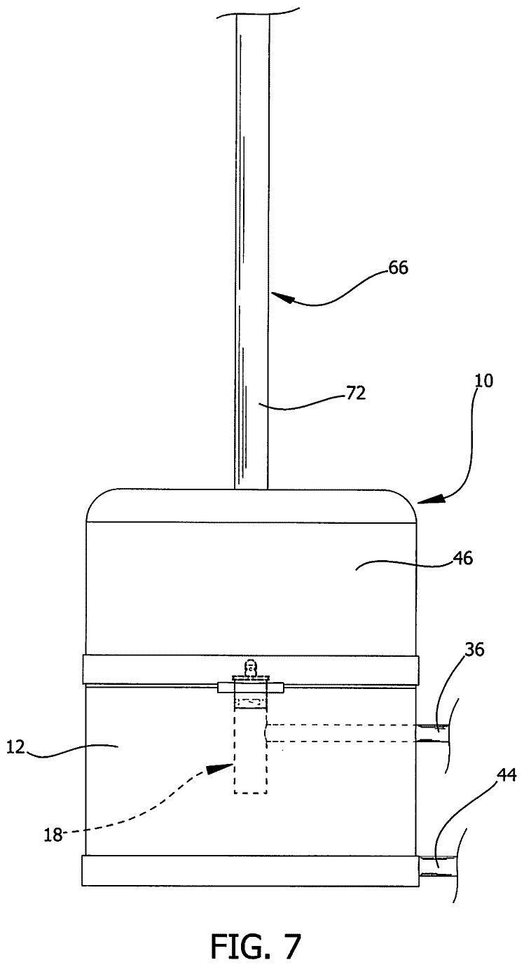

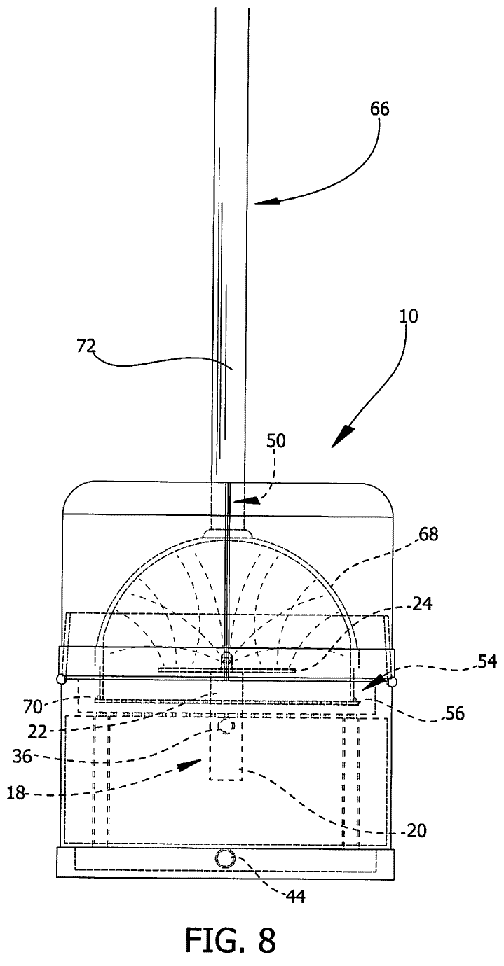

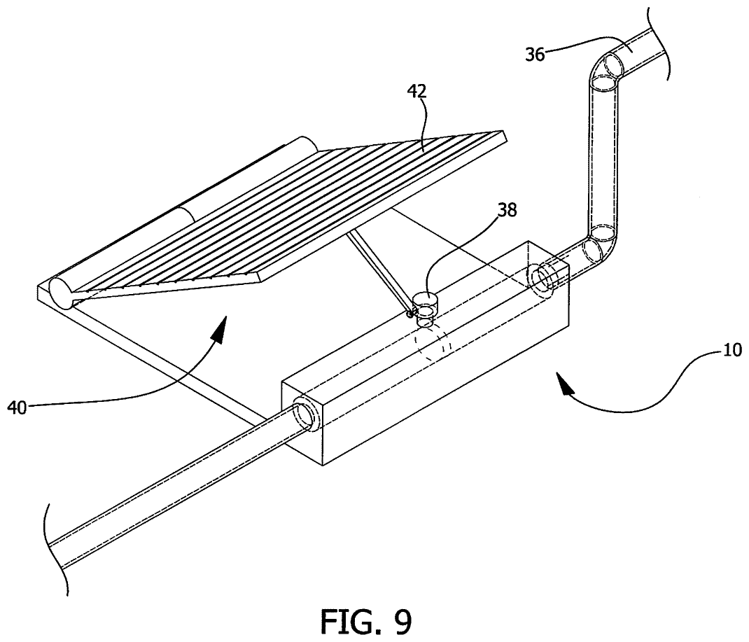

With reference now to the drawings, and in particular to FIGS. 1 through 10 thereof, a new toilet plunger cleaning apparatus embodying the principles and concepts of an embodiment of the disclosure and generally designated by the reference numeral 10 will be described.

As best illustrated in FIGS. 1 through 10, the toilet plunger cleaning apparatus 10 generally comprises a housing 10 with a plunger-receiving opening 12 in a top side of the housing 10. The plunger-receiving opening 12 extends into an interior space 14 of the housing 10. The plunger-receiving opening 12 is sized to receive a cup 68 of a toilet plunger 66. A sprayer 18 is mounted in the housing 10. The sprayer 18 comprises a stator 20, a rotor 22, a head 24, and a turbine 30. The stator 20 is fixedly mounted in the housing 10, and the rotor 22 is rotatably mounted to the stator 20. The head 24 is mounted to the rotor 22 opposite the stator 20. The turbine 30 is mounted in the rotor 22. The sprayer 18 defines a channel 34 which travels through the stator 20, the rotor 22, past the turbine 30, and into the head 24. A plurality of dispensing holes 26 are defined in an upper surface 28 of the head 24 which extend into the channel 34. The turbine 30 comprises blades 32 which are angled to urge the rotor 22 to rotate with respect to the stator 20 when a fluid flows from the stator 20 against the blades 32. The fluid may be urged through the channel 34 and out of the dispensing holes 26 of the head 24. The fluid may be water, a cleaning solution, or any other suitable substance.

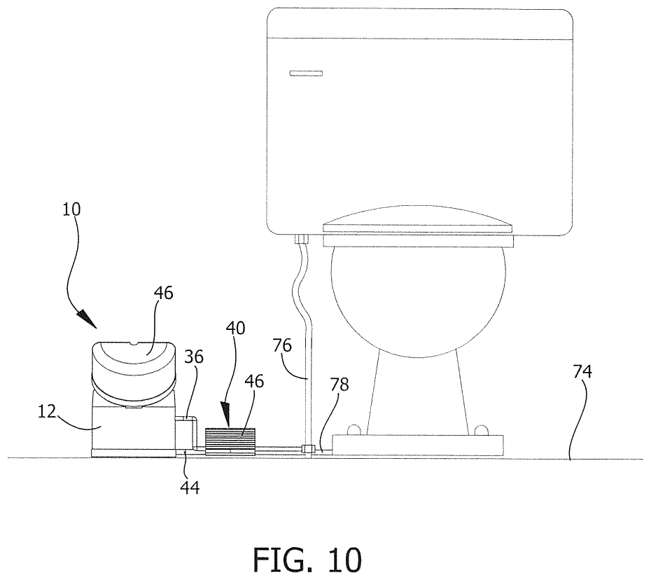

An inlet tube 36 is coupled to and is in fluid communication with the sprayer 18. The inlet tube 36 is configured to be in fluid communication with a fluid source. With reference to FIG. 10, the inlet tube 36 may be coupled to a water supply line 76 in a house plumbing system. The inlet tube 36 may attach to a hot water supply for improved cleaning of the toilet plunger 66. A valve 38 is coupled to the inlet tube 36 and permits the fluid to flow through the inlet tube 36 toward the sprayer 18 only when open. A valve actuator 40 is operatively coupled to the valve 38. The valve actuator 40 comprises a pedal 42 which is pivotable with respect to the valve 38 to alternately open and close the valve 38. The pedal 42 may be positioned on a floor surface 74 and be sized to be operated by a user's foot. A drain tube 44 extends into the interior space 14 of the housing 10 and is configured to drain the fluid from the housing 10. The drain tube 44 may be coupled to a drain line 78 in the house plumbing system or may lead to an open drain.

A pair of lid members 46 is coupled to the housing 10. Each lid member 46 of the pair of lid members 46 is pivotable with respect to the housing 10. The lid members 46 are pivotably alternately toward and away from each other to cover and uncover the plunger-receiving opening 12 respectively. The lid members 46 define a handle-receiving opening 50 therebetween when positioned in a closed configuration 48 with respect to the plunger-receiving opening 12 which is sized to accommodate a handle 72 of the toilet plunger 66. A pair of sealing members 52 is provided, each of which is coupled to an associated lid member 46 of the pair of lid members 46. The sealing members 52 form a seal with each other when the lid members 46 are positioned in the closed configuration 48, thereby preventing the fluid from exiting the housing 10 between the lid members 46.

A lid actuator 54 is operatively coupled to the lid members 46. The lid actuator 54 comprises an engagement member 56 and a pair of links 58. The engagement member 56 is movably mounted in the housing 10, and each link 58 of the pair of links 58 is coupled to and extends between the engagement member 56 and an associated lid member 46 of the pair of lid members 46. The engagement member 56 is movable away from the plunger-receiving opening 12 to urge the lid members 46 into the closed configuration 48 via the links 58. The engagement member 56 is movable toward the plunger-receiving opening 12 to urge the lid members 46 out of the closed configuration 48 via the links 58. The engagement member 56 is biased to urge the lid members 46 into the closed configuration 48 by a pair of compression springs 60, but any other suitable biasing member may be used. For example, torsion springs may urge the lid members 46 out of the closed configuration 48, which could be counteracted by pushing the engagement member 56 away from the plunger-receiving opening 12. The engagement member 56 is positioned around the sprayer 18 and defines an aperture 62 to accommodate the sprayer 18. The engagement member 56 also defines a plurality of drainage holes 64 configured to permit the fluid to drain through the engagement member 56.

In use, a rim 70 of the cup 68 of the toilet plunger 66 is placed against the engagement member 56 around the sprayer 18 to urge the lid members 46 to close around the toilet plunger 66. The compression springs 60 or other biasing members may be configured to move against bias due to the weight of the toilet plunger 66, or a greater force may be required. The valve actuator 40 is actuated to open the valve 38 and release the fluid from the fluid source. The fluid travels through the inlet tube 36 and the sprayer 18, causing the rotor 22 and the head 24 of the sprayer 18 to rotate with respect to the housing 10 and spraying through the dispensing holes 26 against the cup 68 of the toilet plunger 66. As the fluid falls away from the toilet plunger 66 due to gravity, it drains through the drain tube 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A toilet plunger cleaning apparatus comprising:
a housing defining a plunger-receiving opening in a top side of the housing, the plunger-receiving opening extending into an interior space of the housing, the plunger-receiving opening being sized to receive a cup of a toilet plunger; and
a sprayer mounted in the housing and configured to selectively spray a fluid into the interior space of the housing, the sprayer comprising a head which is configured to dispense the fluid while rotating with respect to the housing.

2. The apparatus of claim 1, wherein the sprayer further comprises:
a stator fixedly mounted in the housing;
a rotor rotatably mounted to the stator;
wherein the head is mounted to the rotor opposite the stator;
wherein the sprayer defines a channel which extends through the stator, the rotor, and the head, the head defining a plurality of dispensing holes which extend into the channel, the plurality of dispensing holes being positioned on an upper surface of the head; and
a turbine mounted in the rotor, the turbine comprising blades which are angled to urge the rotor to rotate with respect to the stator when the fluid flows from the stator against the blades.

3. The apparatus of claim 1, further comprising an inlet tube coupled to and in fluid communication with the sprayer, the inlet tube being configured to be in fluid communication with a fluid source.

4. The apparatus of claim 3, further comprising a valve coupled to the inlet tube, the valve permitting the fluid to flow through the inlet tube toward the sprayer only when open.

5. The apparatus of claim 4, further comprising a valve actuator operatively coupled to the valve.

6. The apparatus of claim 5, wherein the valve actuator comprises a pedal which is pivotable with respect to the valve to alternately open and close the valve.

7. The apparatus of claim 1, further comprising a drain tube extending into the interior space of the housing, the drain tube being configured to drain the fluid from the housing.

8. The apparatus of claim 1, further comprising a pair of lid members coupled to the housing, each lid member of the pair of lid members being pivotable with respect to the housing, the lid members being pivotably alternately toward and away from each other to cover and uncover the plunger-receiving hole respectively, the lid members defining a handle-receiving opening therebetween when positioned in a closed configuration with respect to the plunger-receiving opening, the handle-receiving opening being sized to accommodate a handle of the toilet plunger.

9. The apparatus of claim 8, further comprising a pair of sealing members, each sealing member of the pair of sealing members being coupled to an associated lid member of the pair of lid members, the sealing members forming a seal with each other when the lid members are positioned in the closed configuration.

10. The apparatus of claim 8, further comprising a lid actuator operatively coupled to the lid members, the lid actuator being configured to be operated by the toilet plunger when the cup of the toilet plunger is positioned in the housing.

11. The apparatus of claim 10, wherein the lid actuator comprises an engagement member and a pair of links, the engagement member being movably mounted in the housing, each link of the pair of links being coupled to and extending between the engagement member and an associated lid member of the pair of lid members, the engagement member being movable away from the plunger-receiving opening to urge the lid members into the closed configuration via the links, the engagement member being movable toward the plunger-receiving opening to urge the lid members out of the closed configuration via the links.

12. The apparatus of claim 11, wherein the engagement member is biased to urge the lid members into the closed configuration.

13. The apparatus of claim 11, wherein the engagement member is positioned around the sprayer, the engagement member defining an aperture to accommodate the sprayer.

14. The apparatus of claim 11, wherein the engagement member defines a plurality of drainage holes configured to permit the fluid to drain through the engagement member.

15. A toilet plunger cleaning apparatus comprising:
a housing defining a plunger-receiving opening in a top side of the housing, the plunger-receiving opening extending into an interior space of the housing, the plunger-receiving opening being sized to receive a cup of a toilet plunger;
a sprayer mounted in the housing and configured to selectively spray a fluid into the interior space of the housing, the sprayer comprising:
a stator fixedly mounted in the housing;
a rotor rotatably mounted to the stator;
a head mounted to the rotor opposite the stator;
wherein the sprayer defines a channel which extends through the stator, the rotor, and the head, the head defining a plurality of dispensing holes which extend into the channel, the plurality of dispensing holes being positioned on an upper surface of the head; and
a turbine mounted in the rotor, the turbine comprising blades which are angled to urge the rotor to rotate with respect to the stator when the fluid flows from the stator against the blades;
an inlet tube coupled to and in fluid communication with the sprayer, the inlet tube being configured to be in fluid communication with a fluid source;
a drain tube extending into the interior space of the housing, the drain tube being configured to drain the fluid from the housing;
a valve coupled to the inlet tube, the valve permitting the fluid to flow through the inlet tube toward the sprayer only when open;
a valve actuator operatively coupled to the valve, the valve actuator comprising a pedal which is pivotable with respect to the valve to alternately open and close the valve;
a pair of lid members coupled to the housing, each lid member of the pair of lid members being pivotable with respect to the housing, the lid members being pivotably alternately toward and away from each other to cover and uncover the plunger-receiving hole respectively, the lid members defining a handle-receiving opening therebetween when positioned in a closed configuration with respect to the plunger-receiving opening, the handle-receiving opening being sized to accommodate a handle of the toilet plunger;
a pair of sealing members, each sealing member of the pair of sealing members being coupled to an associated lid member of the pair of lid members, the sealing members forming a seal with each other when the lid members are positioned in the closed configuration; and
a lid actuator operatively coupled to the lid members, the lid actuator comprising an engagement member and a pair of links, the engagement member being movably mounted in the housing, each link of the pair of links being coupled to and extending between the engagement member and an associated lid member of the pair of lid members, the engagement member being movable away from the plunger-receiving opening to urge the lid members into the closed configuration via the links, the engagement member being movable toward the plunger-receiving opening to urge the lid members out of the closed configuration via the links, the engagement member being biased to urge the lid members into the closed configuration, the engagement member being positioned around the sprayer, the engagement member defining an aperture to accommodate the sprayer, the engagement member defining a plurality of drainage holes configured to permit the fluid to drain through the engagement member.
